(19) United States
(12) Patent Application Publication
(10) Pub. No.: US 2008/0133319 A1
(43) Pub. Date: Jun. 5, 2008

(54) Method and apparatus of determining effect of price on distribution of time to sell real property

(75) Inventors: Sadashiv Adiga, Hercules, CA (US); Jay Chawla, Hoboken, NJ (US)

Correspondence Address: Raj Abhyanker, LLP;c/o Intellevate, P.O. Box 52050, Minneapolis, MN, 55402, US

(73) Assignee: Oia Intellectuals, Inc.

(21) Appl. No.: 11/607,203

(22) Filed: Nov. 30, 2006

(51) Int. Cl. G06Q 10/00

(52) U.S. Cl. 705/10

(57) ABSTRACT

A method and/or an apparatus of determining effect of offer price on distribution of time to sell real property are disclosed. In one embodiment, a method of helping price a first real property on a computer includes determining a characteristic of a probability distribution on a first length of time to sell the first real property as a function of a first offer price for said first real property. The said first offer price for said first real property may be an MLS listing price for said first real property. The said characteristic of a probability distribution on the length of time to sell said first real property as a function of a first offer price for said real property may be a probability of selling said first real property within a first fixed time as a function of said first offer price for said first real property.

### FIELD OF TECHNOLOGY

This disclosure relates generally to the technical fields of software programming, computer hardware and firmware, real property and statistical technology, and in one example embodiment, a method and apparatus of determining effect of price on distribution of time to sell real property.

### BACKGROUND

The decision of how to price (either to bid or to ask or to meet an offer to buy or sell) for real property is a complex decision for which there is beginning to be some statistical guidance in the form of automated valuation models (AVMs) which are appearing on the Internet and in the hands of real property assessors and agents. Zillow.com™ is one example of an online web-accessible tool to estimate the market value of a real property, in Zillow's case a residential real property.

There are numerous ways to price a house. Real property assessors can use various methodologies to price a property. A commercial property is often priced using a multiple to rents that is based on expected growth rates, interest rates, etc. Residential real property is often priced using comparables analysis taking into account trends, interest rates, local supply and demand conditions, a look at what's currently on the market, unique features of the property, salability of the property based on appearance, upkeep, etc., and many other factors. Automated valuation models are used to determine a price for a house using available data from databases and without the need for human judgment.

Sellers will sometimes lower the price of their house below what they feel they could obtain on the market if they have a need to sell the house quickly. This will attract opportunistic buyers who recognize the value and act quickly to make the purchase. Conventional methods to adjust the price of a house due to a need to sell are heuristic at best, and use intuitive human judgment rather than quantitative analysis.

House buyers sometimes see a property on the market that they find desirable, but they may want to look around more for something that better fits what they want, particularly if they determine that the house is overpriced. If a house is overpriced, a buyer may want information about how long they can wait and look for better opportunities, and how much pressure the seller will feel to lower the price. In the conventional art, there is no quantitative way to approach this analysis. What is needed is a way to quantitatively model the effect of price on the distribution of time to sell real property.

### SUMMARY

A method and/or an apparatus of determining effect of price on distribution of time to sell real property are disclosed. In one aspect, a method of helping price a first real property on a computer includes determining a characteristic of a probability distribution (e.g., the characteristic of the probability distribution on length of time to sell said first real property as a function of a first offer price for said real property may be a probability of selling said first real property within a first fixed time as the function of said first offer price for said first real property) on a first length of time (e.g., the first length of time to sell said first real property may include a time between listing said first real property on a Multiple Listing Service® (MLS) and/or closing a sale on said first real property) to sell the first real property as the function of a first offer price for said first real property.

The said first length of time to sell said first real property may include the time between listing said first real property on the MLS and signing a contract to sell said first real property. The said first offer price for said first real property may be an MLS listing price for said first real property. The characteristic of a probability distribution on the length of time to sell said first real property as a function of an offer price for said real property may be a function of a histogram mapping offer price for said first real property to a set of intervals of time to sell said first house.

In addition, the method may include determining a first objective price (e.g., operation of determining the first objective price for the house comprises using MLS data on a set of house listings and sales.) for said first house. The method may also include using an automated valuation model. The method may include determining a set of objective prices for a subset of said set of real property listings and sales, and the said set of objective prices may include an objective price for each real property in said subset.

Furthermore, the method may include determining, for said subset, a statistical relationship among listing price, objective price, and time to sell. The operation of determining, for said first subset, the statistical relationship, may include determining an empirical property (e.g., the empirical property may be used to determine said characteristic) on said first subset of the probability distribution of time to sell as a function of ratios of listing price and objective price. The empirical property may include a histogram.

The said empirical property may also include the probability that time to sell may be less than a second fixed time as the function of said ratios of listing price and objective price. Also, the said characteristic may be determined using a first ratio between said first offer price and said first objective price and using said probability that time to sell is less than a second fixed time.

In another aspect, a software to help price a real property includes one of a compiled software and one of a programming language software logic object code routine and/or a set of object code routines stored in one of a permanent medium and a computer system memory for providing a computer implemented method that may determine a characteristic of a probability distribution on a first length of time to sell a first real property as a function of a first offer price for said first real property.

Also, the software may include a code for determining an objective price for said first real property. The software may include code for a web interface to use such software over a WWW connection.

In yet another aspect, a method of communicating over an Internet information to help price a real property on a computer includes receiving identification information for said first real property and/or transmitting a characteristic of a probability distribution on a first length of time to sell the first real property as a function of a first offer price for said first real property.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a probability server communicating with a client module through a network, according to one embodiment.

FIG. 2 is a diagrammatic system view of a data processing system in which any of the embodiments disclosed herein may be performed, according to one embodiment.

FIG. 3 is a process flow of determining a characteristic of a probability distribution on a time to sell a real property as a function of offer price, according to one embodiment.

FIG. 4 is a detailed view of a relationship determination module 110, showing 3 optional potential modules within relationship determination module 110.

FIG. 5 is an exemplary user interface screen for specifying a real property to be analyzed.

FIG. 6 is an exemplary user interface screen for displaying a characteristic of a probability distribution on a first length of time to sell the first real property as a function of a first offer price for said first real property.

Other features of the present embodiments will be apparent from the accompanying drawings and from the detailed description that follows.

### DETAILED DESCRIPTION

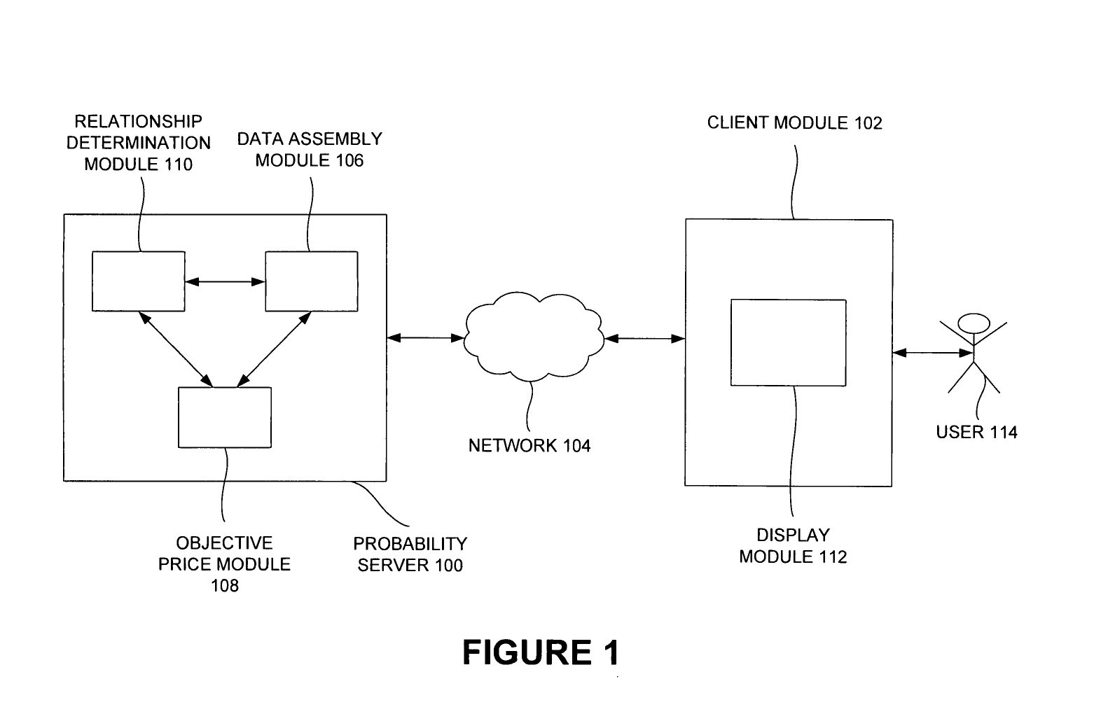

A method and/or an apparatus of determining effect of offer price on distribution of time to sell real property are disclosed. In one embodiment, a method of helping price a first real property on a computer (e.g., probability server 100 of FIG. 1) includes determining a characteristic of a probability distribution on a first length of time to sell the first real property as a function of a first offer price for said first real property.

In another embodiment, a software to help price a real property includes one of a compiled software and one of a programming language software logic object code routine and/or a set of object code routines stored in one of a permanent medium and a computer system memory for providing a computer implemented method that may determine a characteristic of a probability distribution on a first length of time to sell a first real property as a function of a first offer price for said first real property.

In yet another embodiment, a method of communicating over the Internet information to help price a real property on a computer includes receiving identification information for said first real property and/or transmitting a characteristic of a probability distribution on a first length of time to sell the first real property as a function of a first offer price for said first real property.

FIG. 1 shows a system view of a probability server 100 communicating with a client module 102 through a network 104, according to one embodiment. Particularly, FIG. 1 illustrates, the probability server 100, the client devices 102, the network 104, a data assembly module 106, an objective price module 108, a relationship determination module 110 and a display module 112, according to one embodiment.

The probability server 100 may be a software engine (e.g., running compiled software, a programming language software, etc) that may deliver application (e.g., a characteristic of a probability function on a time to sell as a function of offer price) to the client module 102 through the network 104. The probability server 100 may determine a characteristic of a probability distribution on a first length of time to sell a first real property as a function of a first offer price for first real property.

The probability server 100 may receive identification information for said first real property from the client module 102 through the network 104 and/or may transmit the characteristic of the probability distribution on the first length of time to sell the first real property as the function of the first offer price for first real property to the client module 102 through the network 104. The probability server may also be collocated with the client module as software on a single computer with no network connection.

The client module 102 may be a computing system (e.g., a combination of hardware and software that may store and/or retrieve data) that may access the remote services (e.g., effect of offer price on distribution of time to sell real property) on probability server 100 through the network 104. The client module 102 may enable the user 114 to access the expected value of time to sell the real property, the probability that it may not sell without relisting it at a lower price, a table of probabilities of the real property selling during discrete intervals of time, a variance of how long it may take to sell the real property, etc to the client.

The client module 102 may provide precise offline valuation and/or harness the powerful automated analysis to the client. The probability server 100 may contain the data assembly module 106, the objective price module 108, and the relationship determination module 110. The data assembly module 106 may manage (e.g., direct, handle, control, etc) an objective price data, an offer price data, a sales price data, and/or an index of time to sell each property. The data assembly module 106 may also manage the client selected data (e.g., range of prices, location, area, parking space, etc) through a MLS. The data assembly module 106 may assemble (e.g., amass, put together, etc) the data that may be used in determining the characteristic of the probability distribution on time to sell the real property in question based on its offer price and/or may weight the data according to reliability and/or relevance.

The objective price module 108 may be associated with determining the first objective price for the property (e.g., a flat, a bungalow, a house, etc) using MLS data and/or user data on a set of house listings and sales. The objective price module 108 may also determine the objective price using the data from county assessors and county recorders offices. The relationship determination module 110 may be associated with analyzing and/or determining the relationship among the offer price, the objective price and the time to sell using, e.g., a regression formula or other analytics. The relationship determination module 110 may also be associated with determining the characteristic using the empirical property that may include a histogram.

The display 112 of the client module 102 may enable the user (e.g., a realtor, a owner, a buyer, etc) to list the specifications (e.g., the area, the parking facility, the location, number of rooms, etc) and/or may allow the user (e.g., a realtor, a owner, a buyer, etc) to access the objective price, the probability distribution on time to sell the real property conditioned on offer price.

In example embodiment illustrated in FIG. 1, the probability server module 100 may communicate with the client module 102 through a network 104.

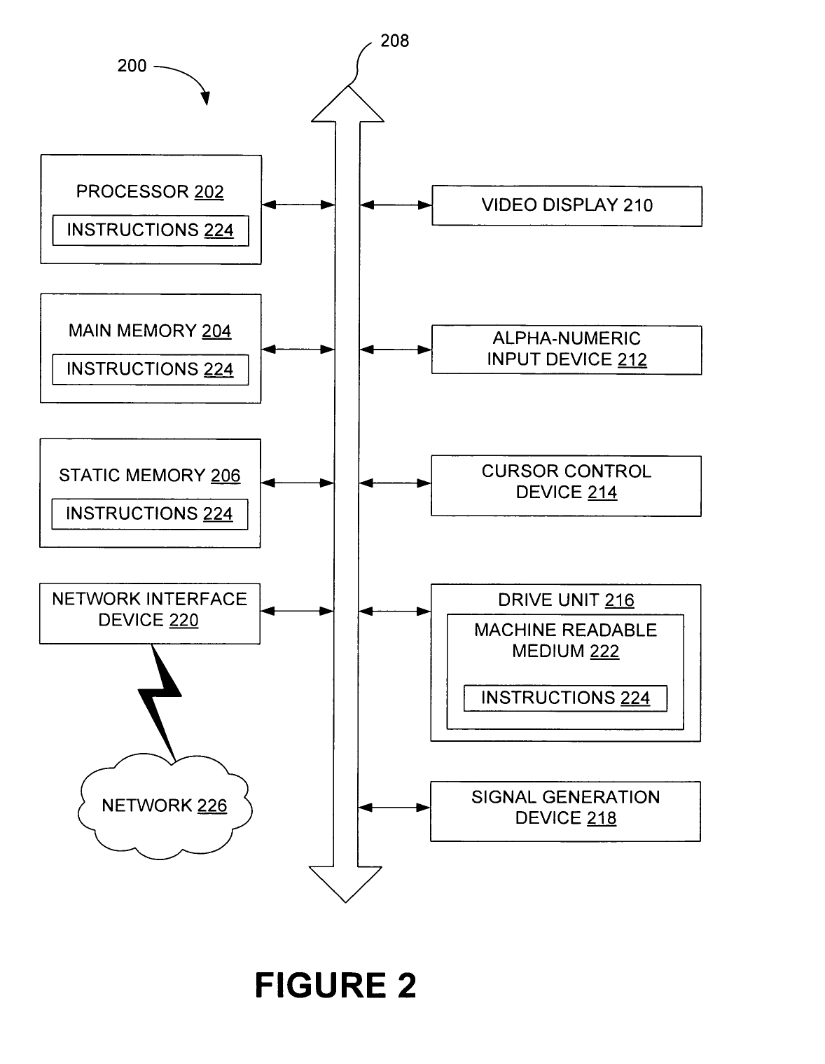

FIG. 2 is a diagrammatic system view 200 of a data processing system in which any of the embodiments disclosed herein may be performed, according to one embodiment. Particularly, the system view 200 of FIG. 2 illustrates a processor 202, a main memory 204, a static memory 206, a bus 208, a video display 210, an alpha-numeric input device 212, a cursor control device 214, a drive unit 216, a signal generation device 218, a machine readable medium 222, instructions 224, and a network 226, according to one embodiment. The diagrammatic system view 200 may indicate a personal computer and/or a data processing system in which one or more operations disclosed herein are performed.

The processor 202 may be microprocessor, a state machine, an application specific integrated circuit, a field programmable gate array, etc. (e.g., Intel® Pentium® processor). The main memory 204 may be a dynamic random access memory and/or a primary memory of a computer system. The static memory 206 may be a hard drive, a flash drive, and/or other memory information associated with the data processing system. The bus 208 may be an interconnection between various circuits and/or structures of the data processing system. The video display 210 may provide graphical representation of information on the data processing system. The alpha-numeric input device 212 may be a keypad, keyboard and/or any other input device of text (e.g., a special device to aid the physically handicapped). The cursor control device 214 may be a pointing device such as a mouse.

The drive unit 216 may be a hard drive, a storage system, and/or other longer term storage subsystem. The signal generation device 218 may be a bios and/or a functional operating system of the data processing system. The machine readable medium 222 may provide instructions on which any of the methods disclosed herein may be performed. The instructions 224 may provide source code and/or data code to the processor 202 to enable any one/or more operations disclosed herein.

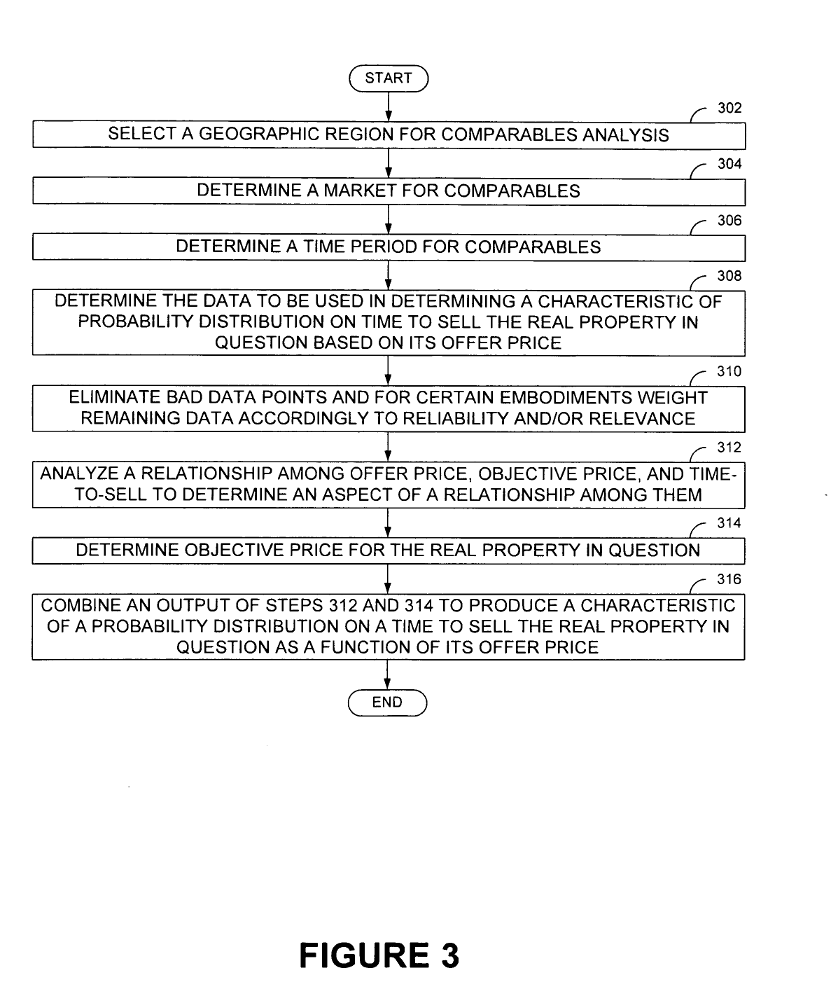

FIG. 3 is a process flow for a probability server 100, according to one embodiment. In operation 302, a geographic region may be selected for comparables analysis. The geographic region may be a region or set of regions with a market similar to the real property for which a characteristic of a probability function on a time to sell as a function of offer price is to be determined. In a preferred embodiment, the region is silicon valley, in which over 90% of the variation in housing prices can be determined by AVM models. (Source: online Wikipedia entry on ‘real property appraisal’.)

In operation 304, a market for comparables is determined. This may be a subset of the real properties in the region that has supply and demand characteristics comparable to the property in question. In a preferred embodiment, the real property to be valued is a residential house, and the preferred market for comparables is standard residential housing in the $500K to $3M range, a mid-range for houses in the preferred region.

In operation 306, a time period for comparables may be chosen. This time period in a preferred embodiment may include many years of sales, but preferably sales that may be recent enough that the housing market may not be qualitatively economically different than it is currently. It is OK to include up- and down-market time periods, buyers- and sellers-market timer periods, high-volume and low volume market time periods in the analysis. In the preferred embodiment, the time period chosen is 2002-2006 comparable sales in the preferred market and region.

In operation 308, the data to be used in determining a characteristic of probability distribution on time to sell the real property in question based on its offer price determined. In a preferred embodiment, that data comprises an objective price, an offer price, a sales price, and an index of time to sell each property selected in operation 306. The offer price for a real property may be determined in the preferred embodiment by searching the MLS, which would only include residential properties sold through a listing agent. This may introduce a bias, but it may be acceptable. Note that residential properties on average achieve a higher sales price in a shorter time to sell when listed through an agent, and this may be compensated for in comparable calculations if desired through the addition or subtraction of estimated correction factors, for example, as would be apparent, if it is desired to correct for such small errors.

In a preferred embodiment, the item of real property may be a residential property such as a house or condominium, and in order to determine a characteristic of a probability distribution on time to sell the real property as a function of offer price, a set of real property listings on the MLS may be considered. This set of real property listings may include a set of residential properties that have already been sold and closed out of the MLS, and/or may be chosen as a representative sample of real properties with some similarity to the real property for which a characteristic of a probability distribution on time to sell as a function of offer price is to be determined. For a subset of this set, objective prices are determined. An objective price for any element of this subset could be a price determined by an AVM taking into account information available at the time the real property was listed, it could be a final sale price, it could be a price determined an a real property assessor at the time of listing, an adjusted tax assessed value, an adjusted most recent sale value, or other objective prices as would be apparent to one of skill in the art.

In other embodiments, objective prices could be determined using data from county assessors and county recorders offices, or other sources as would be apparent. In operation 310, bad data points may be eliminated, and for certain embodiments, remaining data are weighted according to reliability and/or relevance. For example, in a preferred embodiment, residential properties from MLS data are considered. Some of those properties may have sold for twice their listed value—they should be excluded as ‘bad’ data. Additionally, data may be weighted and/or used in a weighted regression formula or other weighted formula in operation 312. Data may be weighted by estimated errors. Real properties for which estimation error on an objective price are considered too high could be eliminated or alternatively emphasized less in operation 312.

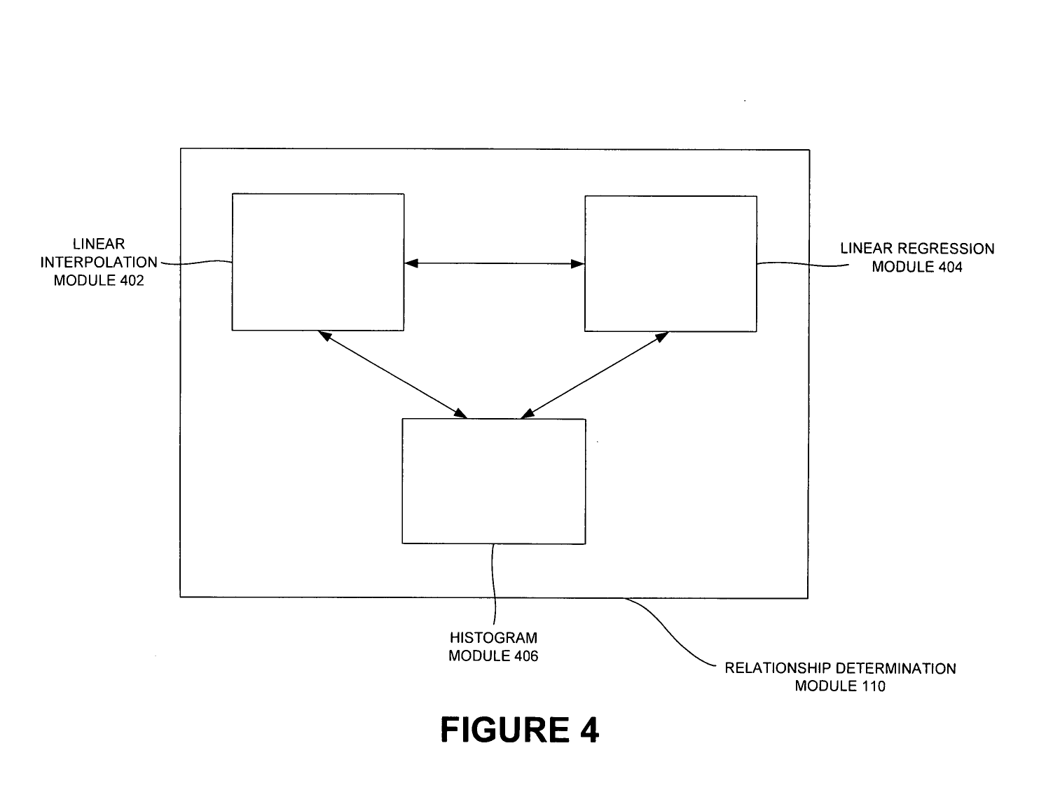

In operation 312, a relationship among offer price, objective price, and time-to-sell may be analyzed to determine an aspect of a relationship among them. This relationship is preferably an empirical characteristic based on historical data. This step is preferably carried out in relationship determination module 110, using various modules in different embodiments such as exemplary modules shown in FIG. 4: linear interpolation module 402, linear regression module 404, and/or histogram module 406. Other modules including nonlinear, fuzzy logic, non-Bayesian, neural network, genetic algorithm, etc. relationship determination modules may be used as apparent.

In Histogram module 406, data may be bucketed according to various variables such as intervals of ratio of offer price to objective price, e.g., [0.5,0.6], (0,0.7], (0.7,0.8], (0.8,0.9],(0.9,1],(1,1.1], (1.1,1.2],(1.2,1.3],(1.3,1.4], (1.4,1.5],(1.5,infinity), as well as intervals of time to sell, e.g., [0,1 day], [2 days, 1 week), [1 week, 1 month), [1 month, 1 year), [never], or other intervals as desired. Then, characteristics in each bucket may be extracted, such as, for example, in the (1,1.1] bucket on price ratio, what is the probability of selling in less than 1 week? Similar properties could be extracted for other buckets as well. Linear interpolation between bucket values could be used to map such properties from buckets such as (1,1.1] to specific ratios, such as 1.03, within a bucket. For example, suppose the probability of selling in less than a week in the (1,1.1] bucket is 20% and the probability of selling in less than a week in the (0.9,1.1] bucket is 50%. Then linear regression module 404 may solve using centroids of buckets, a linear interpolated value of [(1.03−0.95)*20%+(1.05−1.03)50%]/(1.05−0.95)=26% chance of selling in less than a week for a ratio of 1.03. It can be estimated that, in the region of (0.9,1.05), lowering asking price by 1% of offer price gives a 3% increase in the probability of selling the real property within 1 week. Such pricing sensitivity information may be valuable to a distress seller who needs the cash, for example.

In another embodiment, a regression formula may be used in linear regression module 404 or a nonlinear variant thereof to determine a relationship among offer price, objective price, and time-to-sell. A linear regression may use a set of observed pairs of data (in one embodiment, a ratio of offer to objective price, and a time-to-sell) to determine an optimal form mapping independent observation data variables (formed into a vector) to a dependent target variable. In one embodiment, the observation data variables are a scalar—the ratio of offer to objective price—but other formulations and additional data may be used, such as, for example, current state of the market, e.g., is it a buyers or sellers market (which would be a binary value). In a preferred implementation, the dependent target variable may be the percentile of the distribution on time to sell that is achieved for a comparable region and time period by each real property.

A percentile may be used if the time to sell is not uniformly distributed; converting to a percentile value may make time to sell uniform and better formatted for a regression. For example, if 43% of real properties in a comparable market (region, time period, similar property types) sold within 24 days, and a property for regression sold in 24 days, we would use 0.43 as the ‘time to sell’ value for that real property, as we are using a percentile value for that variable. Other transformations of variables may be used, as would be apparent. (Furthermore, such transformations, including the percentile transformation, may be used in histogram embodiments as well to ensure uniformity of data in different market conditions. Such transformations could be reversed based on current market conditions in operation 316 in any case.) For example, in addition to using a ratio of offer to objective price, objective price could be separately inputted into the regression as an independent variable.

Then the regression would be free to find additional information embedded in the magnitude of the price of the house and how it impacts time-to-sell. (For example, very expensive residential real properties tend to sell more slowly than moderately priced ones and this may take that into account in a regression on residential properties. Alternatively, separate regressions may be done for different price ranges of real properties—but aggregation of different comparable data sets is typically done in operation 308.)

Later observations of independent variables without the dependent variable may use the solved linear regression form that may estimate the dependent variable as well as an estimation error in the dependent variable.

For a linear regression embodiment, it is desired to estimate yᵢ=α+βxᵢ+εᵢ for i=1, . . . ,n for observed pairs xᵢ, yᵢ, here xᵢ are our independent observations vectors (e.g., price ratio), yᵢ is are the parameters to be estimated (e.g., time-to-sell) as affine functions of the observation vectors, and α is a constant scalar and β a constant vector to be determined. Optimal choices of α and β lead to an unbiased estimate of the set of parameters to be estimated with minimum variance

$$( {\sum }_{i = 1}^{n} {( {ɛ}_{i} )}^{2} )$$

it we assume that The random errors ε have zero expected value, are uncorrelated with each other, and have identical variance.

By recognizing that the yᵢ=α+βxᵢ+εᵢ regression model is a system of linear equations we can express the model using data matrix X, target vector Y and parameter vector δ. The i^{th} row of X and Y will contain the x and y value for the tth data sample. Then the model may be written as

$$[ \begin{matrix}{y}_{1} \\ {y}_{2} \\ ⋮ \\ {y}_{n}\end{matrix} ] = [ \begin{matrix}1 & {x}_{1} \\ 1 & {x}_{2} \\ ⋮ & ⋮ \\ 1 & {x}_{n}\end{matrix} ] [ \begin{matrix}α \\ β\end{matrix} ] + [ \begin{matrix}{ɛ}_{1} \\ {ɛ}_{2} \\ ⋮ \\ {ɛ}_{n}\end{matrix} ]$$

which when using pure matrix notation becomes

$$Y = X δ + ɛ$$

$$\hat{δ} = {( {X}^{′} X )}^{- 1} {X}^{′} Y$$

$${ɛ}^{′} ɛ = {\sum }_{i = 1}^{n} {( {ɛ}_{i} )}^{2} = {Y}^{′} ( {I}_{n} - {X ( {X}^{′} X )}^{- 1} {X}^{′} ) Y .$$

As would be apparent to one of skill in the art, the regression need not be linear. Instead of xβ in the equation above, a nonlinear function such as x²β or β EXP[^{xk}] may be used, as well as a myriad of other functions known of those of skill in the art. One must ensure that the form of the regression may be still linear in β, as would be apparent to one of skill in the art, because then the same linear regression tools may be used on the modified functional form of the X vector. One of skill in the art can look at a scatter plot of the linear regression data and/or see if there may be a pattern to the errors. If there is, say a square-order pattern, then a square form may be used for the regression. The regression may be still linear.

As would also be apparent, a weighted regression may be done as is standard in the art, where some data is more reliable (e.g., lower error estimates in objective price) or important (e.g., higher similarity of region or property type) to the real property in question.

In operation 314, an objective price for the real property in question may be determined. In a preferred embodiment, this may be done using a linear regression on a number of characteristics of the real property. In the preferred embodiment, these factors may be for a residential property as it will be listed in the MLS. Many regression formulas are available in the industry and the same regression techniques described for operation 312 may be used, as would be apparent to one of skill in the art. The dependent variable may be house price, and independent variables may include, e.g., Property

### Type: residential,

### Type: single family, condo/town home, Mobile home

### Asking Price

### Major Area

### Available Area

### Bedrooms

### Total Baths

### Waterfront

Garage type: (none, attached, detached, attached+detached)

### Garage: 1 car, 2 cars, 3 cars, 4 cars

Additionally, multiple linear regressions could be done for different subsets or categories of real properties in the region, and some regression variables could take binary values, e.g., whether there may be a garage, or a garage with room for 4 cars, what year or market condition time period it is, what school or neighborhood and/or urban area one is in etc. In some embodiments, spatial information in 2 dimensions or projections to one dimension such as distance to landmarks, etc. could be used

In alternative embodiments, the real property may be valued by an assessor or a real property agent. Alternatively, financial characteristics of a commercial property could be entered into a cash flow/multiple-based valuation program such as a spreadsheet model.

Differing objectives of speed of use of the program versus accuracy of the results may be traded off to determine how best to price the real property. A user could just enter an objective price for the real property in question as well. This may allow precise, offline valuation and/or harness the powerful automated analysis done in operation 312.

In operation 316, an output of operations 312 and 314 may be combined to produce a characteristic of a probability distribution on a time to sell the real property in question as a function of its offer price. In one embodiment, in which a regression may be used to output a percentile (which would be truncated at 0/100) of time-to-sell distribution, that percentile may be translated back to an actual time-to-sell based on current market conditions. That way, the regression may be invariant to market conditions and generalizes them. Current market conditions may be translated into a map from percentile to time-to-sell. For example, if it is a slow market, the bottom 20% of real properties may not sell at all without repricing. That could be noted, e.g., as infinite time to sell or the distribution would be truncated at the 80^{th} percentile.

In other embodiments, other characteristics of the probability distribution on the time to sell the real property as a function of offer price may be determined, such as an expected value of time to sell the real property, a probability that it will not sell without relisting it at a lower price, a histogram of probabilities of the real property selling during discrete intervals of time, a variance of how long it takes to sell the real property, and the like. Conditional characteristics, such as the additional time to sell given passage of a first amount of time, or additional time to sell if an offer of some type is refused, or the time to sell if multiple offers for the real property are received rapidly, may be determined in alternative embodiments. Many other characteristics of the probability distribution as a function of offer price may be determined as would be apparent to one of skill in the art.

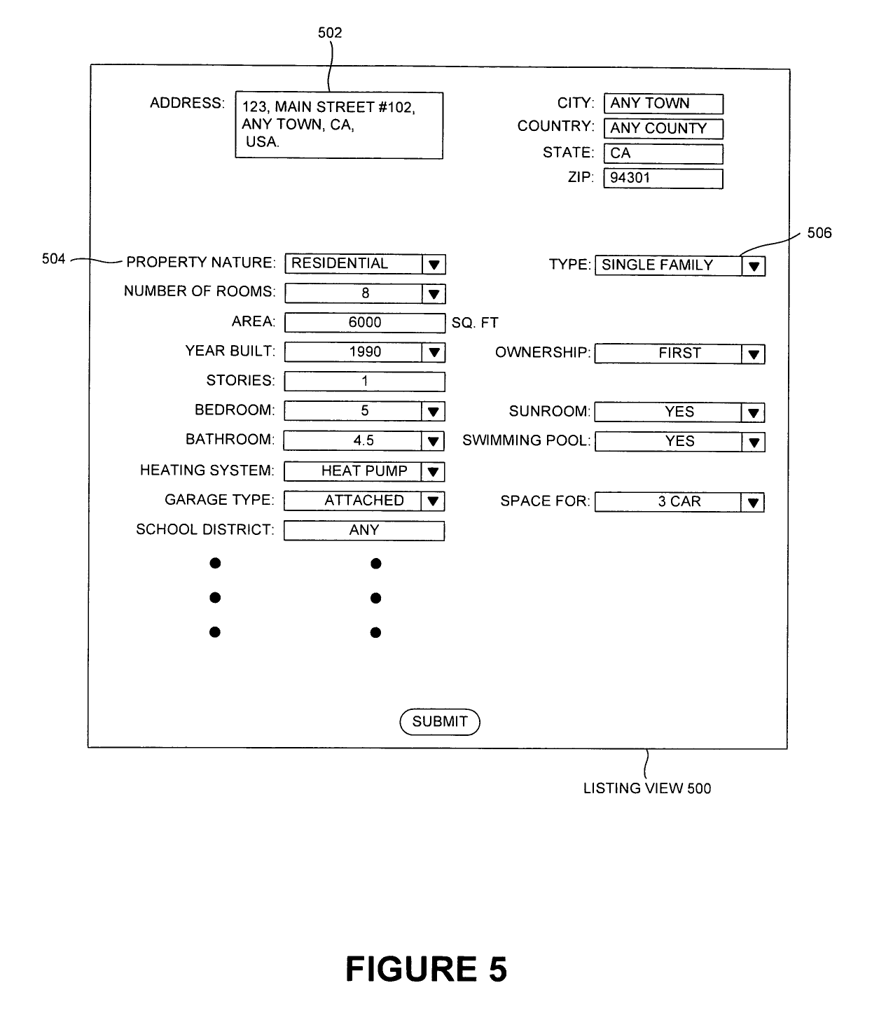

Display module 112 in client module 102 may be accessed in some embodiments by user 114 through a graphical user interface. In other embodiments, automated or other procedures may be used. FIG. 5 shows a user input screen for a listing view 500 in one embodiment. User 114 enters various data, or alternatively enters an address 502 in a free-form text field with possible constraints, drop down options, and/or radio buttons, and data is pulled from a source such as, for some residential real properties, the MLS. In an exemplary embodiment, data specifying a real property may include property nature 504, which could be implemented as a drop down menu with selections including e.g., residential, commercial, and mixed use. Some data field may depend on others in the case of partial or facilitated user entry. E.g., exemplary type field 506 may depend on property nature. For example, if ‘residential’ is selected as property nature, type could create a pull-down selection menu comprising, e.g., single family, condominium, coop, duplex, and the like. The data in listing view 500 data may be submitted by the user or through another method, such as automatically, pulled from various data sources, and/or possibly customized with extra user inputs. In some cases, a user may enter improvements or intangible factors relevant to pricing a home. Subjective factors may be taken into account or not, and possibly discounted due to their subjective nature. In some embodiments, data for comparables in the past or presently listed real properties may be entered automatically or by humans for use by data assembly module 106, relationship determination module 110, and/or objective price determination module 108 or other modules as would be apparent. FIG. 5 shows a subset of exemplary possible input fields that may or may not be shown. Various fields may be drop down, selectors, numbers, or free text, as would be apparent.

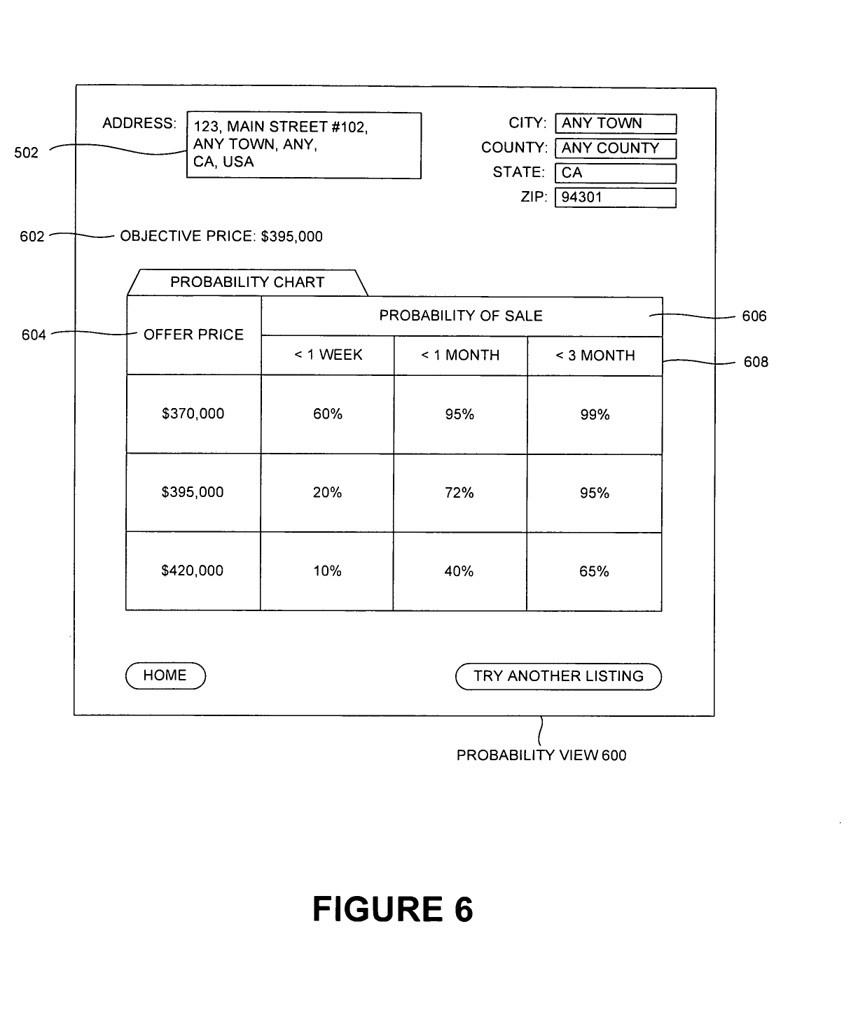

After user 114 presses the ‘submit’ button in FIG. 5, a probability view 600 may be displayed, as shown in an exemplary embodiment in FIG. 6. An objective price 602 may be shown, as determined by objective price module 108 based on user inputs supplied in the input screen and/or automatically supplied. In the exemplary case shown in FIGS. 5 and 6, objective price 602 is $395K. Additionally, identification information for the real property, such as its address 502, may be shown. In addition, a characteristic of a probability distribution on time to sell the real property may be shown for one or more offer prices, selected according to a schedule or by user 114. In the exemplary case shown, three possible offer prices 604 are shown, and probabilities 606 of selling the real property within 3 different lengths of time 608 are shown. Other numbers and lengths of time may be shown, such as ‘never sold’ and/or user-supplied or adjustable offer prices and/or lengths of time may be entered into probability view 600 via various input fields or automatically according to fixed and/or customizable templates, as would be apparent. For example, if the real property is offered at its objective price 602, $395K, it will sell within a month with probability 606 72%, as shown. Raising the offer price 604 $25K to $420K would reduce the probability of selling 606 the real property within a month to 40%, and lowering the offer price 604 $25K to $370K would raise the probability of selling 606 the real property within a month to 95%.

Although the present embodiments have been described with reference to specific example embodiments, it will be evident that various modifications and changes may be made to these embodiments without departing from the broader spirit and scope of the various embodiments. Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various modules discussed herein may be enabled using transistors, logic gates, and electrical circuits (e.g., application specific integrated ASIC circuitry) using circuitry.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of helping price a first real property on a computer, comprising:
determining a characteristic of a probability distribution on a first length of time to sell the first real property as a function of a first offer price for said first real property.

2. The method of claim 1, wherein said first length of time to sell said first real property comprises a time between listing said first real property on the MLS and closing a sale on said first real property.

3. The method of claim 1, wherein said first length of time to sell said first real property comprises a time between listing said first real property on the MLS and signing a contract to sell said first real property.

4. The method of claim 1, wherein said first offer price for said first real property is an MLS listing price for said first real property.

5. The method of claim 1, wherein said characteristic of a probability distribution on the length of time to sell said first real property as a function of a first offer price for said real property is a probability of selling said first real property within a first fixed time as a function of said first offer price for said first real property.

6. The method of claim 1 wherein said characteristic of a probability distribution on the length of time to sell said first real property as a function of an offer price for said real property is a function of a histogram mapping offer price for said first real property to a set of intervals of time to sell said first house.

7. The method of claim 1 further comprising determining a first objective price for said first house.

8. The method of claim 7 wherein said operation of determining a first objective price for the house comprises using MLS data on a set of house listings and sales.

9. The method of claim 8 further comprising using an automated valuation model.

10. The method of claim 7 further comprising determining a set of objective prices for a subset of said set of real property listings and sales, wherein said set of objective prices comprises an objective price for each real property in said subset.

11. The method of claim 10, further comprising determining, for said subset, a statistical relationship among listing price, objective price, and time to sell.

12. The method of claim 11, wherein said operation of determining, for said first subset, a statistical relationship, comprises determining an empirical property on said first subset of a probability distribution of time to sell as a function of ratios of listing price and objective price.

13. The method of claim 12 wherein said empirical property is used to determine said characteristic.

14. The method of claim 12, wherein said empirical property comprises a histogram.

15. The method of claim 12, wherein said empirical property comprises a probability that time to sell is less than a second fixed time as a function of said ratios of listing price and objective price.

16. The method of claim 15 wherein said characteristic is determined using a first ratio between said first offer price and said first objective price and using said probability that time to sell is less than a second fixed time.

17. A software to help price a real property, comprising:
one of a complied software and one of a programming language software logic object code routing and a set of object code routing stored in one of a permanent medium and a computer system memory for providing a computer implemented method to determine a characteristic of a probability distribution on a first length of time to sell a first real property as a function of first offer price for said first real property.

18. The software of claim 17 further comprising code for determining an objective price for said first real property.

19. The software of claim 17, further comprising code for a web interface to use such software over a WWW connection.

20. A method of communicating over the Internet information to help price a real property on a computer, comprising:
receiving identification information for said first real property, and
transmitting a characteristic of a probability distribution on a first length of time to sell the first real property as a function of a first offer price for said first real property.
